(19) United States
(12) Patent Application Publication
(10) Pub. No.: US 2003/0113251 A1
(43) Pub. Date: Jun. 19, 2003

(54) Method for preparing shape-changed nanosize colloidal silica

(75) Inventors: Zong-Whie Shih, Taoyuan (TW); Kai-Yia Chang, Taipei (TW); Chun-Lan Tseng, Taoyuan (TW); Chun-Yuan Ro, Panchiao (TW)

Correspondence Address: BACON & THOMAS, PLLC, 625 SLATERS LANE, FOURTH FLOOR, ALEXANDRIA, VA, 22314

(73) Assignee: Chung Shan Institute of Science & Technology, Taoyuan (TW)

(21) Appl. No.: 10/310,872

(22) Filed: Dec. 6, 2002

(30) Foreign Application Priority Data
Dec. 7, 2001 (TW) 90130447

(51) Int. Cl. C01B 33/12

(52) U.S. Cl. 423/338

(57) ABSTRACT

A method for preparing shape-changed nanosize colloidal silica comprising the following steps: a). providing a nanosize spherical colloidal silica solution having an average diameter no more than 100 nm; b). adding a coagulant having a concentration no more than 5 wt % and an active silicic acid to the colloidal silica solution, and raising the reaction temperature; and c). keeping addition of said active silicic acid to said solution obtained from step b) continuously until the concentration of SiO₂ reaches 6 to 50% by weight.

### FIELD OF THE INVENTION

The present invention relates to a method for preparing shape-changed nanosize colloidal silica. More particularly, it relates to a method for preparing shape-changed nanosize colloidal silica suitable for chemical mechanical polishing (CMP) processes.

### BACKGROUND OF THE INVENTION

Chemical mechanical polishing (CMP) slurry consists of a suspension and abrasive. Generally speaking, the chemical mechanical polishing for wafers is achieved by the chemical etching ability provided by the suspension and by the mechanical polishing ability provided by the abrasive. Especially the abrasive has critical effects on removing rates and wafer surface defects. Usually, the polishing slurry for wafers might be distinguished into two categories, i.e. dielectric layer and metal layer. The abrasive for dielectric layer are SiO₂ (e.g. U.S. Pat. No. 4,910,155 and U.S. Pat. No. 5,169,491) while the abrasive for metal layerare Al₂O₃ (e.g. U.S. Pat. No. 5,209,816 and U.S. Pat. No. 5,244,534). In addition to the suspension and the abrasive, various etchants, oxidants, and stabilizers are also added to the polishing suspension to perform a uniform slurry. The species and the concentration of the chemicals in the slurry strongly effects the factors for evaluating the polishing slurry such as removing rate, non-uniformity, scratching on the wafer surface, purity, and slurry shelf life.

The silica used for the dielectric layer slurry usually are fumed silica, colloidal silica, or others according to their production process. In most cases, fumed silica is generally produced by the combustion of silicon tetrachloride in a hydrogen oxygen flame at high temperature. In this process, the particle size of silica nucleus are about several nanometer. These particles collide and fuse to form the spherical primary particles which are subsequently sintered to form three dimensional, branched, chain-like aggregates called secondary particles, of approximately 130 nm to 180 nm in size.

On the other hand, colloidal silica is generally produced by chemical synthesis, especially by growing ultra-fine colloidal silica particles obtained by cation ion exchange of sodium silicate. The primary and secondary particle diameters of colloidal silica are both on the nanometer scale, and the colloidal silica shows excellent dispersibility in solution when compared with fumed silica. Therefore, the aggregation resulted after a period of storage in fumed silica slurry is absent in colloidal silica.

At present, the polishing slurry of dielectric layer mainly comprises fumed silica as abrasive. The fumed silica is dispersed in a basic solution uniformly by a shearing force (e.g. U.S. Pat. No. 5,116,535 and U.S. Pat. No. 5,246,624). It is well known that the fumed silica is good for the CMP process for wafers having line width greater than 0.25 μm. But it is also known that the performance of fumed silica slurry is not so good for the wafer having line width less than 0.25 μm. However, for meeting high efficiency trends, low weight and low volume in the semi-conductor industrial field, the development of copper process progresses from 0.25 μm to 0.18 μm in length. Since fumed silica with 130 nm to 180 nm secondary particle diameter is not suitable anymore, and colloidal silica with smaller particle diameter is more and more important in the semi-conductor industrial field.

In 1950, traditional processes used for producing colloidal silica were well developed, and the products were used for refractory materials, ceramic fibers, binders with precision casting, metal surfactants, and anti-sliding reagents for paper and fibers. However, the purity and hardness of traditional colloidal silica are not good enough to polish wafers. In recent years, the colloidal silica slurry suitable for wafer polishing has been developed, but the removing rate of said colloidal silica is much lower than that of fumed silica. Furthermore, in order to achieve good removing rate, the solid content of the colloidal silica slurry must be up to 30% by weight. So the colloidal silica mentioned above is not popular in the semi-conductor industrial field, and a new kind of colloidal silica needs to be developed to meet CMP process requirements.

### SUMMARY OF THE INVENTION

One object of the present invention is to provide a method for preparing shape-changed nanosize colloidal silica to produce colloidal silica suitable for chemical mechanical polishing (CMP) processes.

Another object of the present invention is to provide a method for preparing short-chain like nanosize colloidal silica.

To achieve the purposes of the present invention, a method for preparing shape-changed nanosize colloidal silica is provided, which comprises: a). providing a nanosize spherical colloidal silica having an average diameter no more than 100 nm, b). adding a coagulant having a concentration no more than 5 wt % and an active silicic acid to the colloidal silica, and raising the reaction temperature; and c). adding the active silicic acid to the reaction solution continuously until the SiO₂ concentration is up to 6 to 50% by weight.

The shape-changed nanosize colloidal silica is characterized in that the primary particle diameter is between 10 and 100 nm while the secondary particle diameter is between 20 and 200 nm, wherein said colloidal silica is suitable for CMP processes.

### BRIEF DESCRIPTION OF THE DRAWINGS

FIG. 1 is the electric microscope photograph of the nanosize spherical colloidal silica according to the present invention.

### DETAILED DESCRIPTION OF THE PREFERRED EMBODIMENTS

After studying and researching profoundly, the present inventor discovered that:

(1) The smaller the primary particle diameter and the greater the abrasive grain hardness, the better the removing rate; the smaller the primary particle diameter and the less defective on the abrasive grain surface producing higher quality polishing; the smaller the primary particle diameter and the larger the abrasive grain specific surface area, the better the obtained adsorbed microparticles wafer cleaning rate.

(2) The larger the abrasive grain secondary particle diameter, the better the removing rate.

(3) The spherical abrasive grains will reduce the removing rate since it will interact with the surface abraded by relative motion.

Therefore, the present invention is characterized in providing a method for preparing shape-changed nanosize colloidal silica, which has a small primary particle diameter, a large specific surface area, and a large secondary particle diameter.

According to the method of the present invention, a nanosize spherical colloidal silica having an average diameter no more than 100 nm, preferably 10 to 100 nm, is provided, and the colloidal silica's pH is adjusted between 7 to 11 which is followed by adding a coagulant having a concentration no more than 5 wt % and an active silicic acid to the colloidal silica, subsequently raising the reaction temperature, preferably 60 to 100

Said coagulant is used for compressing the electric double layers of the silica particles to increase the probability for forming aggregation. The coagulant is selected from weak acidic salt or weak basic salt, the corresponding acid of the pre-mentioned salt, or the said salt and said acid mixture. The preferred embodiments of said salt are at least one selected from the group consisting of carbonate, nitrate, sulfate, borate, and phosphate, while the preferred embodiments of said acid are at least one selected from the group consisting of carbonic acid, nitric acid, sulfuric acid, boric acid, and phosphoric acid.

In addition, said active silicic acid is obtained by cation exchange of silicate solution, preferably sodium silicate, wherein the cation exchange resin is not limited, preferably Amberjet 1500H (Rohm & Haas Co.). The coagulant and active silicic acid addition order are also not limited. During the reaction, the silica particles aggregate to change shape (from spherical to short-chain like), solidify their structure and enlarge. The active silicic acid is added continuously to the heated reaction until the SiO₂ concentration reaches 6 to 50% by weight. Continuous stirring is necessary to form uniform particles in the process mentioned above.

The shape-changed nanosize colloidal silica produced by the methods according to the present invention is measured by a acoustic spectrometer DT-1200 (Dispersion Technology Co.) to determine primary particle diameter, and by a Laser particle diameter analyzer Zetasizer (Malvern Co.) to determine the secondary particle diameter. The results show that colloidal silica with 10 to 100 nm primary particle diameter and 20 to 200 nm secondary particle diameter are obtained. The removing rate of obtained colloidal silica is as good as fumed silica's, which is suitable for the polishing slurry used in CMP process.

The present invention can be well understood with the following embodiments, but the range of the present invention is not limited to the illustrated examples.

All the obtained particle are measured by a acoustic spectrometer DT-1200 (Dispersion Technology Co.) to determine the primary particle diameter, and by a Laser particle diameter analyzer Zetasizer (Malvern Co.) to determine the secondary particle diameter.

### EXAMPLE 1

### The Effects of Coagulant on Spherical Colloidal Silica

140 g of colloidal silica solution with a 54 nm average diameter and 0.56 g of potassium nitrate were mixed in a reaction bottle with stirring, and the temperature thereof was raised to 80° C. and maintained for 6 h. The particle shape observed by SEM was chain-like, with a 98.4 nm secondary particle diameter.

### EXAMPLE 2

### Preparation of Shape-Changed Nanosize Colloidal Silica

5732 g of deionized water was added to 1720 g of sodium silicate followed by treatment with cation exchange resin to obtain active silicic acid.

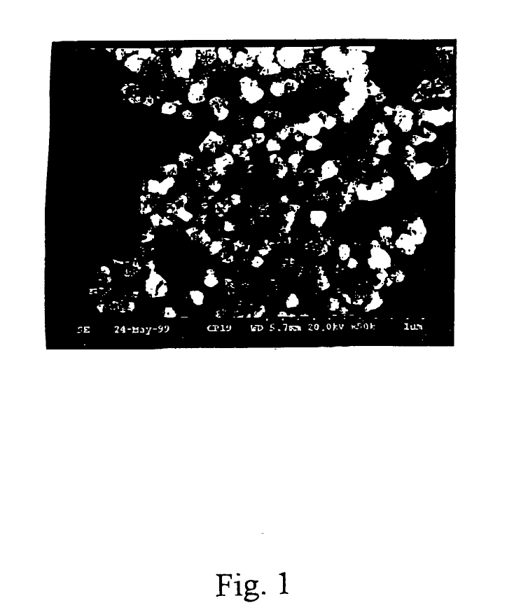

140 g of colloidal silica solution with an average 54 nm colloidal silica diameter was subjected into a 3 L glass reaction vessel with stirring equipment, the pH thereof was adjusted to 10.0 by KOH. The solution was stirred and heated by oil-bath until boiling, and 50 g of potassium carbonate (52 wt %) was subsequently added into the solution. The active silicic acid was then added into the reaction with an 18 ml/min feeding rate. The product was obtained with 25.7% by weight of SiO₂, pH of 10.2, viscosity of 3.3 cp, 61.6 nm primary particle diameter, and 114 nm secondary particle diameter. The electric microscope photograph is shown as FIG. 1.

### EXAMPLE 3

### Preparation of Shape-Changed Nanosize Colloidal Silica and Removing Rate Comparison

1648 g of deionized water was added to 430 g of sodium silicate followed by treatment with cation exchange resin to obtain active silicic acid.

2000 g of colloidal silica solution with a 54.6 nm average colloidal silica diameter was subjected into a 3 L glass reaction vessel with stirring equipment; the pH thereof was adjusted to 10.4 by KOH. The solution was stirred and heated by oil-bath until boiling, and 40 g of potassium carbonate (37.5 wt %) was subsequently added to the solution. The active silicic acid was then added to the reaction with a 20 ml/min feeding rate. The obtained product had a SiO₂ concentration of 25.4% by weight, pH of 10.5, viscosity of 2.7 cp, primary particle diameter of 57.6 nm, and secondary particle diameter of 91.1 nm.

The product was used for polishing a Thermal oxide medium layer of wafers on a Westech 372M CMP apparatus, wherein the polishing condition was as follows:

| | | |
|---|---|---|
| Down Force = | 8 | psi |
| Back Force = | 3 | psi |
| Platen Speed = | 25 | rpm |
| Carrier Speed = | 20 | rpm |
| Slurry Flow = | 150 | ml/min |

On the other hand, the spherical colloidal silica slurry and the fumed silica slurry SS-25 that were purchased from Cabot Co. for CMP processes were used to polish under the same polishing conditions, and the results were listed on Table I.

TABLE I

| | Spherical | Shape-changed | Cabot SS-25 |
|---|---|---|---|
| Sample | Colloidal Silica | Colloidal Silica | Fumed Silica |
| SiO₂ | 15 | 15 | 12.5 |
| Concentration | | | |
| (wt %) | | | |
| Removing Rate | 1207 | 1682 | 1669 |
| (Å/min) | | | |

The results in Table 1 show that the removing rate of colloidal silica according to the present invention was higher than that of traditional spherical colloidal silica, and it is as good as the fumed silica removing rate.

### EXAMPLE 4

### Large-Scale Preparation of Shape-Changed Nanosize Colloidal Silica

43.1 kg of deionized water was added to 11.5 kg of sodium silicate followed by treatment with cation exchange resin to obtain active silicic acid.

50 kg of colloidal silica solution with a 25.2 nm average colloidal silica diameter was transferred into a 70 L stainless steel reaction tank with stirring equipment; the pH thereof was adjusted to 10.0 by KOH. The solution was stirred and heated under steam until boiling, and 1 kg of potassium carbonate (65 wt %) was subsequently added to the solution. The active silicic acid was then added to the reaction with a 500 ml/min feeding rate. The obtained product had a SiO₂ concentration of 11.3% by weight, pH of 10.5, viscosity of 2 cp, primary particle diameter of 35.5 nm, and secondary particle diameter of 92.1 nm.

The shape-changed nanosize colloidal silica produced by the methods according to present invention are characterized in that the primary particle diameter is 10 to 100 nm and the secondary particle diameter is 20 to 200 nm. Compared with conventional colloidal silica slurries, removing rate of shape-changed silica slurry is much higher. On the other hand, the colloidal silica according to the present invention is characterized by nanosize primary particle diameter which can alleviate the wafer surface scratching problem caused by large particle fumed silica attrition and is suitable for nanosize semiconductor processes. In addition, since the slurry's solid content is below 30% by weight, the process is characterized by lower cost and greater competitive ability.

The present invention can certainly achieve the purpose of the present invention with disclosed structures. Its novelty, progressiveness, and usability by production industry complies with the essence of invention patents. Those disclosed above are better application examples. From the foregoing description, one skilled in the art can easily ascertain the essential characteristics of this invention, and without departing from the spirit and scope thereof, can make various changes and modifications of the invention to adapt it to various usages and conditions. Thus, other embodiments are also within the claims.

What is claimed is:

1. A method for preparing shape-changed nanosize colloidal silica comprising the following steps:
a). providing a nanosize spherical colloidal silica solution having an average diameter no more than 100 nm;
b). adding a coagulant having a concentration no more than 5 wt % and an active silicic acid to the colloidal silica solution, and raising the reaction temperature; and
c). keeping addition of said active silicic acid to said solution obtained from step b) continuously until the concentration of SiO₂ reaches 6 to 50% by weight.

2. A method of claim 1, wherein said active silicic acid is obtained by ion exchange of silicate solution.

3. A method of claim 2, wherein said silicate solution is sodium silicate solution.

4. A method of claim 1, further comprising a step of adjusting the pH of the colloidal silica solution in a range between 7 to 11 before adding said coagulant into the solution.

5. A method of claim 1, wherein the reaction temperature of step (b) raises to a range between 60 and 100.

6. A method of claim 1, wherein said colloidal silica has an average particle diameter between 10 nm and 100 nm.

7. A method of claim 1, wherein said coagulant is a weak acidic salt or a weak basic salt, a corresponding acid of said salt, or a mixture of said salt and said acid.

8. A method of claim 1, wherein at least one said coagulant is selected from the group consisting of carbonate, nitrate, sulfate, borate, and phosphate.

9. A method of claim 1, wherein at least one said coagulant is selected from the group consisting of carbonic acid, nitric acid, sulfuric acid, boric acid, and phosphoric acid.

10. A method of claim 1, wherein said coagulant is present in an amount between 0.1% and 5% by weight.

11. A method of claim 1, wherein said coagulant is present in an amount between 0.1% and 3% by weight.

12. A method of claim 1, wherein said active silicic acid is present in an amount no more than 15% by weight.

13. A method of claim 1, wherein the said coagulant added to said colloidal silica solution before, after or during addition of said active silicic acid.

14. A method of claim 1, wherein step (b) and (c) further comprise continuous stirring in the reaction.
